(19) United States
(12) Patent Application Publication
(10) Pub. No.: US 2005/0061269 A1
(43) Pub. Date: Mar. 24, 2005

(54) Stotler variable displacement radial rotary piston engine

(76) Inventor: Scott Gregory Stotler, Walnut Creek, CA (US)

Correspondence Address: Scott G. Stotler, 110 Greenway Drive, Walnut Creek, CA, 94596, US

(21) Appl. No.: 10/667,907

(22) Filed: Sep. 22, 2003

(51) Int. Cl. F02B 53/00; F02B 75/22

(52) U.S. Cl. 123/45 R

(57) ABSTRACT

An internal four-cycle combustion engine with a hub that acts as a rotary valve that rotates in relation to at least one piston is provided. The rotary valve hub includes passageways to provide for fuel/air intake, exhaust, and coolant as well as an ignition devise and services all cylinders around it. Each piston compresses inward toward the hub and is actuated by a cam affixed to the hub. The cam may be articulated to provide the engine with variable displacement and variable compression ratio.

### BACKGROUND OF THE INVENTION

This design has been developed from the Stotler Radial Rotary Piston Engine patent application Ser. No. 10/245,968 to provide variable engine displacement and variable compression ratio. This patent details the use of a cam to drive the pistons instead of crankshafts as presented in the seventh claim of the aforementioned patent application. The use of a cam to actuate the pistons instead of crankshafts provides several advantages. The piston position is controlled by the shape of the cam and not the circular motion of a crankshaft. The cam profile can position the piston anywhere with regards to the rotational position of the hub. A simple articulation of the cam mechanism results in varying the engine displacement by changing the length of the strokes. The dimensions of the combustion chamber can be left constant so this also has the effect of varying the compression ratio of the engine. The result is an engine that can be very fuel-efficient and clean burning during partial throttle but provide very high power output when desired.

### SUMMARY OF THE INVENTION

The present invention comprises an internal combustion engine with at least one piston and a hub that acts as a rotary valve. Multiple pistons, six in this example, are arranged radially around the central hub and compress inward toward the hub. The hub acts as a single rotary valve that services all the pistons around it. The rotary valve hub includes passageways to provide for fuel/air intake, exhaust, and coolant as well as an ignition devise. The pistons are actuated by a cam that is affixed to the hub. As the hub rotates once in relation to the piston cylinder it opens to provide a fuel air mixture during the intake stroke of the piston, seals the cylinder for the compression stroke, ignites combustion, remains sealed for the power stroke and opens the cylinder to allow gasses to escape during the exhaust stroke. The use of a cam to actuate the pistons in this radial design allows the four piston strokes to vary in length. For instance, the compression stroke can be shorter or longer than the combustion stroke. In addition the top dead center combustion chamber volume can differ from the top dead center chamber volume between valve actuation. In fact the term top dead center no longer need apply to this system as the piston position is controlled by the shape of the cam and not the circular motion of a crankshaft. Changing the cam profile during operation can be done if the cam is split into two halves. A simple articulation of the cam halves results in varying the engine displacement. This also has the effect of varying the compression ratio of the engine.

### BRIEF DESCIPTIONS OF THE DRAWINGS

The accompanying drawings illustrate the invention and in such drawings:

FIG. 1 is a view of the engine of the present invention.

FIG. 2 is a side view of the engine.

FIG. 3 is a perpendicular cross sectional view of FIG. 2 through broken line A.

FIG. 4 is similar to FIG. 2 except some of the outer housing has been removed.

FIG. 5 is a perpendicular cross sectional view of FIG. 4 through broken line A.

FIG. 6 is similar to FIG. 4 except that the hub assembly has been rotated.

FIG. 7 is a perpendicular cross sectional view of FIG. 6 through broken line A.

FIG. 8 is a view of the hub and cam assembly.

FIG. 9 shows the other side of the hub and cam assembly.

FIG. 10 is a view from the front of the engine.

FIG. 11 is a perpendicular cross sectional view of FIG. 10 through broken line B.

### DETAILED DESCRIPTION OF THE INVENTION

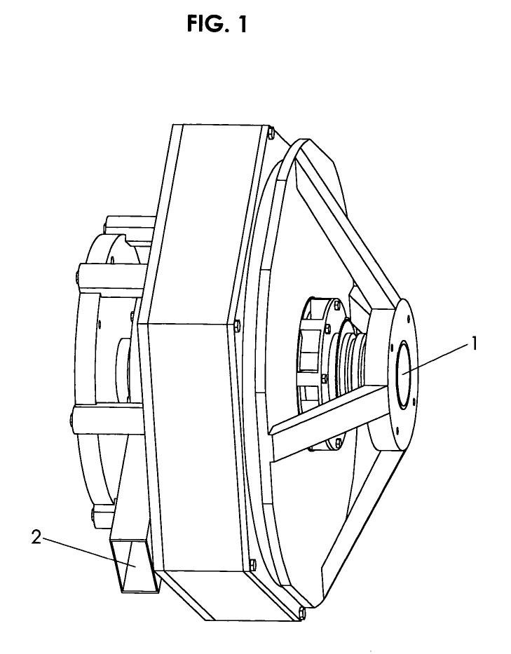

FIG. 1 is a view of the engine of the present invention with six cylinders. This view shows the appearance of the engine from the outside. Notation 1 is the passageway where the air-fuel mixture enters the engine. The rest of the induction system is not depicted and is not included in this patent. Notation 2 is the passageway where the exhaust exits the engine. The rest of the exhaust system and drive train is not depicted and is not included in this patent.

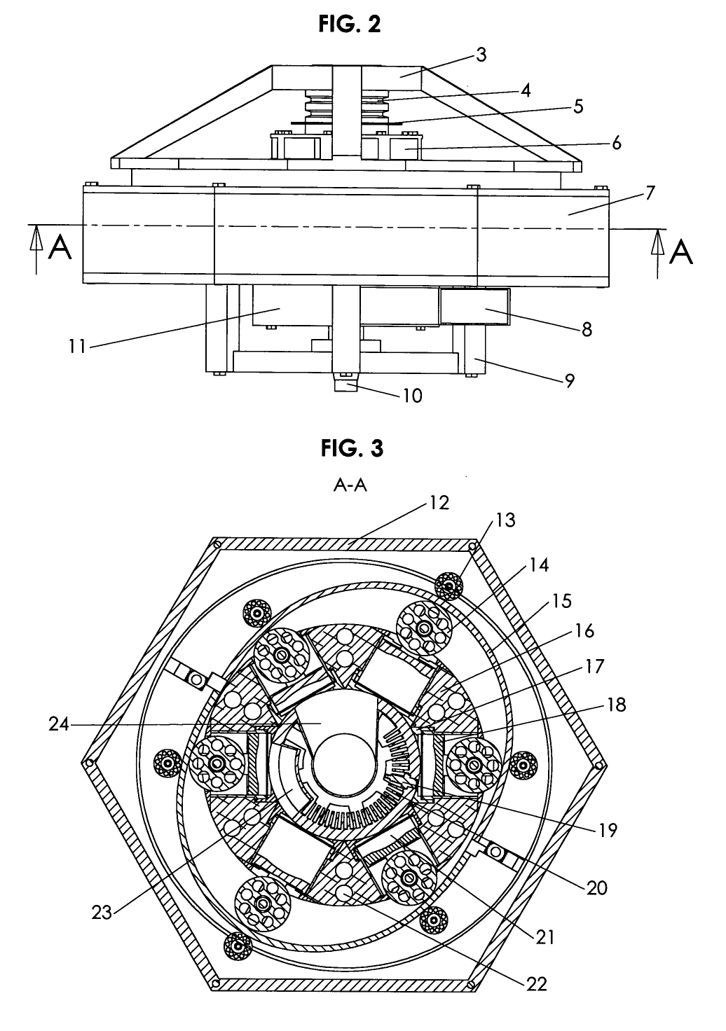

FIG. 2 is a side view of the engine. Item 3 is the front structure of the engine. The primary function of this structure is to mount the front main bearing of the engine. It also provides a mounting point for the intake manifold, alternator, water pump, and other accessories (all not shown). Item 4 is a fan belt groove and is part of the hub assembly that rotates in conjunction with the hub. These two grooves are provided to drive any accessories as needed. Item 5 is a timing wheel that is used for the ignition system (not shown). Item 6 is a passageway that allows air to cool the hub. As the hub spins, centrifugal action draws airs through the engine and out these openings much like a vented disk brake. Item 7 is the outer housing of the engine and also functions to hold the engine oil. Item 8 is the exhaust passageway. Item 9 provides a mount for the rear main bearing as well as the clutch and transmission (not shown). Item 10 is the crank shaft. The flywheel (not shown) would mount to this. Item 11 is the exhaust manifold.

FIG. 3 is a perpendicular cross sectional view of FIG. 2 through broken line A and perpendicular to the axis of rotation. Item 12 is the outer housing (same as Item 7). Item 13 is the outer bearing attached to the piston. This consists of a wheel mounted on a high-speed ball bearing. Item 14 is the inner bearing attached to the piston. This consists of a wheel mounted on two high-speed ball bearings. The inner bearings will be subjected to the far greater forces of combustion so they are made larger and stronger. Item 15 is the cam which rotates in conjunction to the hub assembly. The inner and outer piston bearings ride on the cam. As the cam/hub assembly rotates, the bearings transmit linear motion to the pistons and vise versa. This cam is divided into two halves and is shown here in the expanded position. The articulation of these two cam halves allows for the variable displacement of this engine. Item 16 is the engine block. Item 17 is a cylinder seal that is spring loaded against the hub. This acts similar to a head gasket and rides against the hub and floats concentric to the cylinder liner. The tightness of this seal is determined by the strengths of the springs and the compression ratio. Compression in the cylinder acts to tighten this seal. Item 18 is the piston. Item 19 is the spark plug. This is mounted within the hub assembly. The spark plug is seen here positioned to allow for a large timing advance. If more spark energy or a greater range of spark advance is desired additional spark plugs or glow plugs can be added. Item 20 is one of many cooling fins in the hub. Air pulled through these fins act to cool the hub. Notation 21 shows the cylinder chamber during the combustion stroke. Notation 22 shows a coolant passageway through the engine block. Notation 23 shows the exhaust passageway through the hub. Notation 24 shows the intake passageway through the hub.

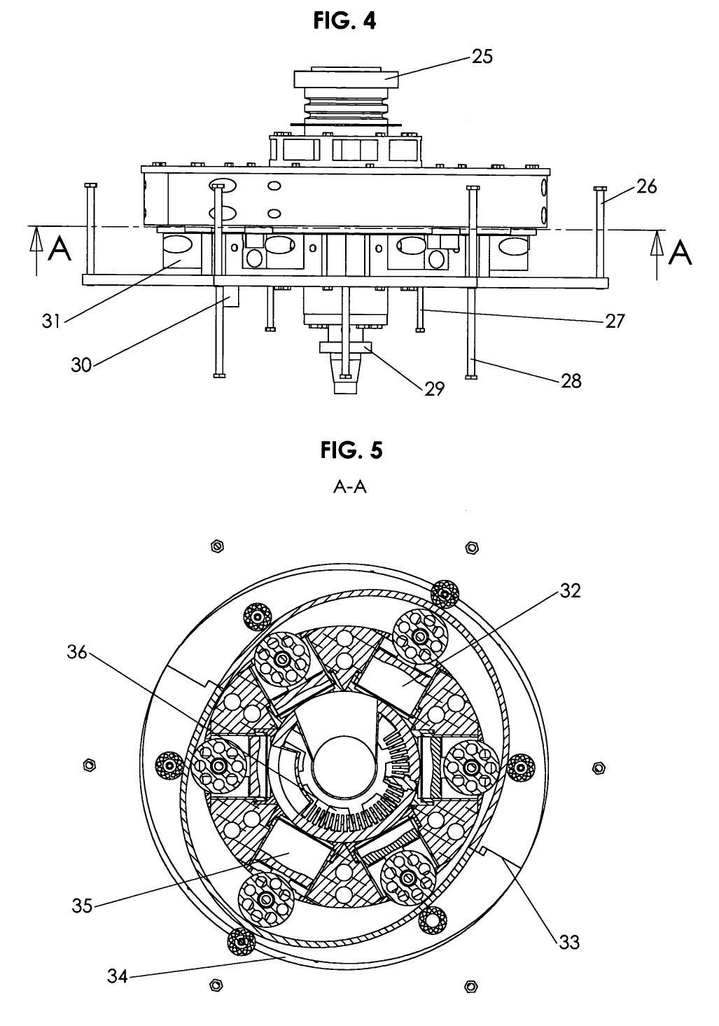

FIG. 4 is a view similar to FIG. 2 except some of the outer housing has been removed to reveal some of the inner components. Item 25 is the front main bearing of the hub. Item 26 is a bolt to hold together the outer housings. Item 27 is an exhaust manifold bolt. Item 28 is a transmission mount bolt. Item 29 is the rear main bearing for the hub assembly. Item 30 is one of the coolant passageways for the block. The second coolant passageway is located directly behind item 30 in this view. Item 31 is a component that maintains the alignment of the piston within the cylinder.

FIG. 5 is a perpendicular cross sectional view of FIG. 4 through broken line A and perpendicular to the axis of rotation. FIG. 5 shows the cam in the position that results in the engine's minimum displaces where as FIG. 3 shows the cam expanded in the position of maximum engine displacement. Notation 32 shows the cylinder chamber at the end of the intake stroke. Notation 33 shows where the two halves of the cam contact each other when the engine is at minimum displacement. Item 34 is part of the hub assembly that has been revealed from the movement of the cam half inward. Notation 36 shows the cylinder chamber at the end of the combustion stroke. When compared to FIG. 3 the stroke of the pistons of notations 32 and 35 has been reduced by the same amount as the displacement seen at 34. The articulation of the cam halves does not alter the piston top dead center position at notation 33. The height of the combustion chamber is always constant. Increasing the engine displacement while maintaining the same combustions chamber dimensions has the effect of increasing the compression ratio. The use of a cam to move the pistons allows the lengths of the intake stroke and combustion stroke to be different. This can be seen by comparing the piston positions at notations 32 and 35. Notation 36 shows one of the air passageways through the center of the hub.

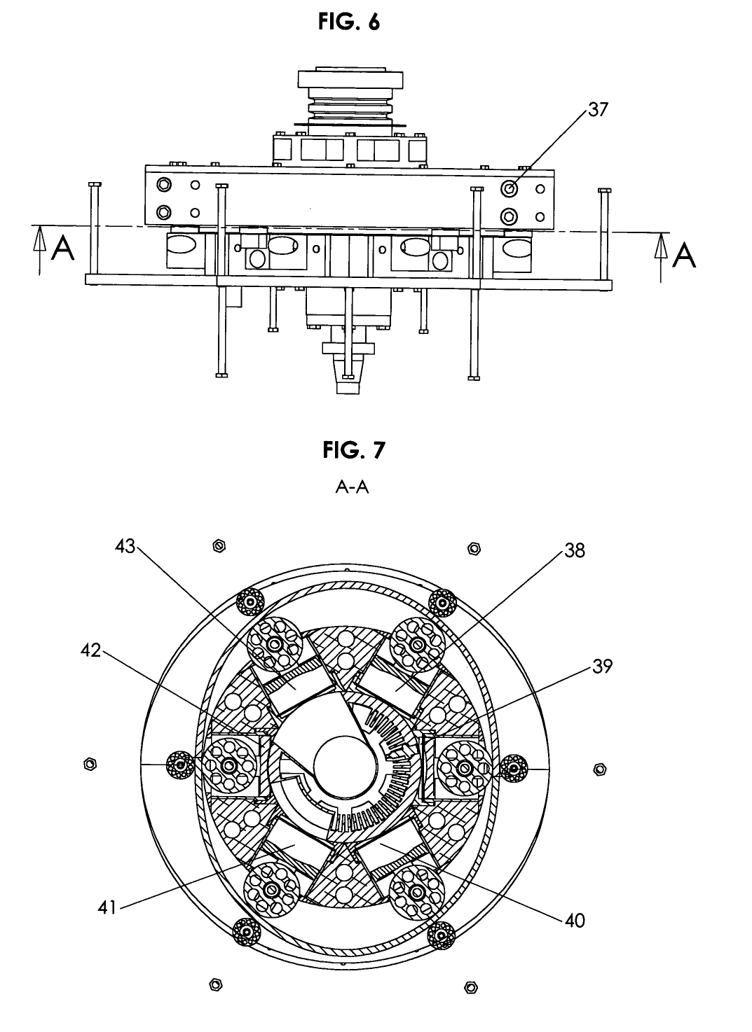

FIG. 6 is similar to FIG. 4 except that the hub assembly has been rotated relative to the block. Item 37 is one of cam bolts and can now be seen.

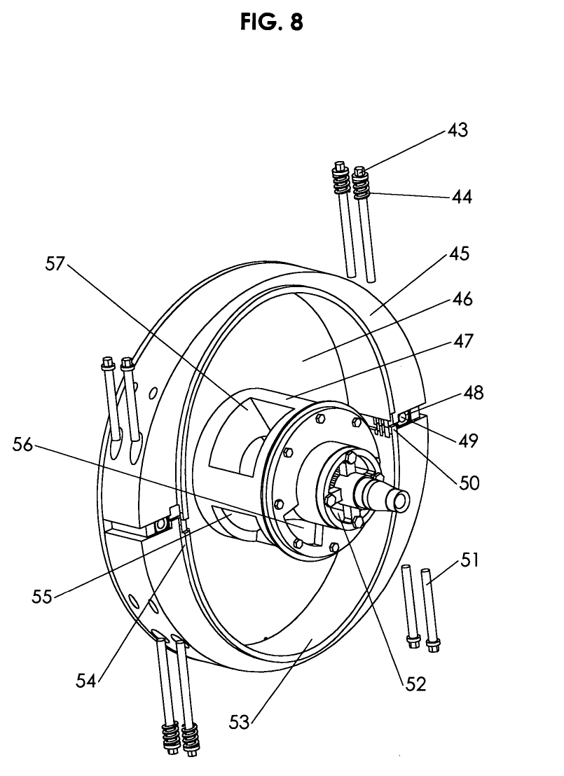

FIG. 7 is a perpendicular cross sectional view of FIG. 6 through broken line A and perpendicular to the axis of rotation. Notation 38 is the cylinder chamber during the compression stroke. Notation 39 is the cylinder chamber at top dead center and the beginning of the combustion stroke. Notation 40 is the cylinder chamber during the combustion stroke. Notation 41 is the cylinder chamber during the exhaust stroke with the cylinder opened to the exhaust passageway of the hub. Item 42 is the piston in the top dead center position. The cam profile allows the top dead center piston position to be different at Item 42 to that at notation 39 (the combustion position). The exhaust stroke can be set to empty the cylinder to near zero volume without any valve overlap. The flexibility of the cam to position the piston in any desired position relative the hub allows this design to offer many tuning options. In addition to independently setting stroke lengths the acceleration of the piston between end points can be set. The pistons can also be held at the end of the stroke for a period of time if desired.

FIG. 8 is a view of the hub and cam assembly. The bolts holding the cam halves together have been extracted and revealed. Item 43 is one of four bolts used to mount springs within the cam assembly. These four springs (item 44) act to hold the cam halves (item 45) together in the minimum displacement position. During engine operation three other forces with also be acting on the cam halves. Centrifugal forces will act to expand the cam halves as the rpm of the engine increases. So after the rpm reaches a certain value, the cam halves will be held in the maximum displacement position. The forces within the cylinders will also act to expand or close the cam halves corresponding to throttle position. With the throttle closed, the engine vacuum created in the intake cylinder will act to close the two cam halves together. As the throttle is opened, the reduction in vacuum in the intake cylinders and the increase in combustion pressures in the expansion cylinders will act to separate the cam halves and increase the engine displacement. The strength of the cam springs will determine how the engine displacement will respond to rpm and throttle inputs.

Item 46 connects the hub assembly with the two cam halves. Item 47 is the hub with many of its passageways in view. Item 48 is one of two gears that make the cam halves expand symmetrically and helps to keep them in alignment. Linking these two gears with another gear in the location of Item 46 (but not shown) would ensure that the two cam halves would expand symmetrically. Item 49 is a bolt in connection with item 46. Notation 50 shows how the cam halves are intermeshed at the point of cam half separation. The cam surface interlocks here to provide a smooth surface for the piston bearings to ride upon during cam articulation. The length of these interlocking fingers determines how much displacement can be added to the engine. Item 51 is a non-spring loaded bolt. Its function is to limit the expansion of the cam halves and maintain their alignment. Notation 53 shows the cam surface where the inner piston bearings ride. Notation 54 shows the cam surface where the outer piston bearings ride.

Notation 52 shows the passageway where air enters the hub assembly to cool it. Notation 55 shows the hub passageway where exhaust gasses leave the pistons. Notation 56 shows the passageway where exhaust gasses leave the hub assembly to enter the exhaust manifold. Notation 57 shows the fuel-air passageway through the hub where it would then enter into the cylinders.

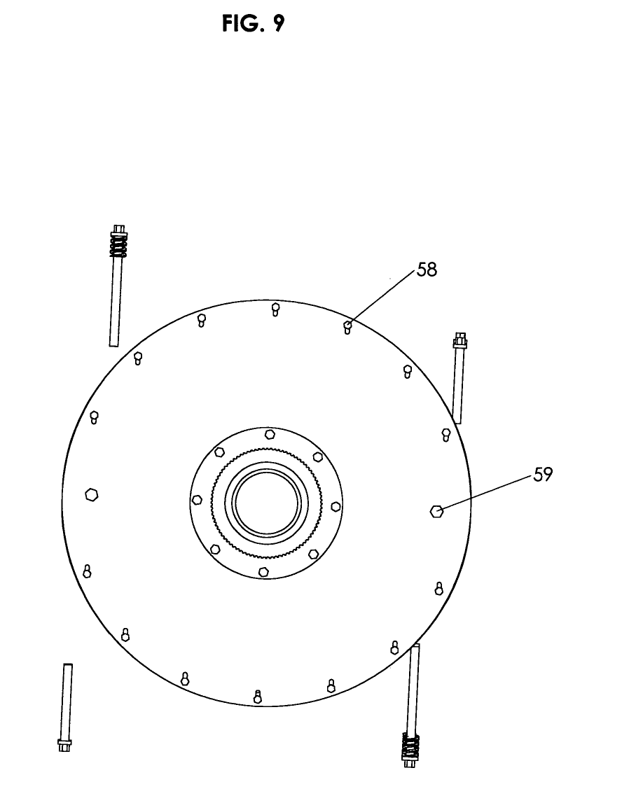

FIG. 9 shows the other side of the hub and cam assembly. Item 59 is one of the main bolts connecting to the cam assembly (same as item 49). It is solidly bolted to the hub assembly. The other smaller bolts similar to item 58 are bolted directly to the cam halves but mount in grooves in the hub assembly. They move to allow the articulation of the cam while still transferring engine torque to the hub assembly.

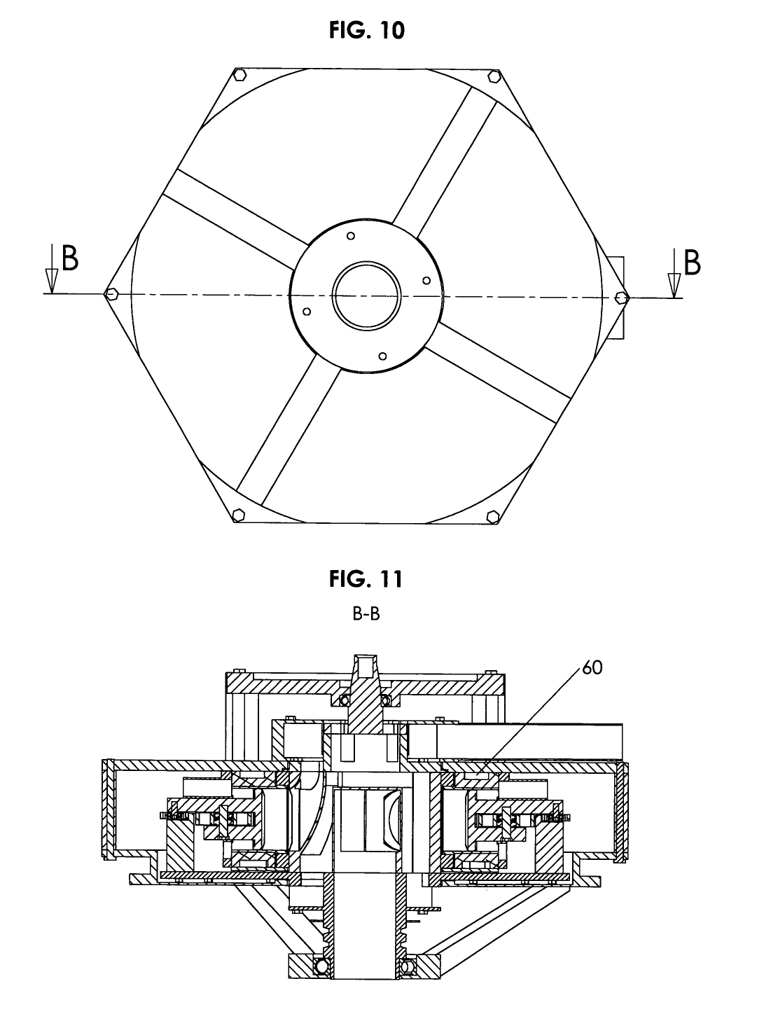

FIG. 10 is a view from the front of the engine.

FIG. 11 is a perpendicular cross sectional view of FIG. 10 through broken line B and parallel to the axis of rotation. Notation 60 shows one of the coolant passageways through the block. These coolant passageways are arranged in a polygon to provide even cooling of the block and connect to the crossing passageways as depicted by notation 22. Connected, these passageways are fed by one entry and one exit point to the engine at notation 30.

To match various applications, the engine of the type of the present invention may be made with multiple rings with any number of radially aligned pistons therefore providing for an unlimited number of pistons and configurations.

Several embodiments of the present invention have been described in detail; however, various modifications may be made without departing from the scope and spirit of the invention. Accordingly the present invention is not to be limited, and is based upon the following claims.

1. An internal combustion four-cycle engine with one or more cylinders arranged radially around the axis of engine rotation with cam driven pistons that compress inward and with a central hub that acts as a rotary valve for all the pistons around it.

2. The central rotary valve hub of the system of claim 1 that includes: a passageway for a fuel/air mixture to enter the cylinders during the intake stroke, an ignition device, a passageway for exhaust gasses to exit the cylinders during the exhaust stroke, and passageways for coolant.

3. The system of claim 1, wherein the cam assembly can be articulated to permit variable engine displacement and variable engine compression during operation.

4. The system of claim 1, wherein the cam assembly is not articulated and consists of one fixed cam surface.

5. The system of claim 1, wherein a water injector may be added near the spark plug to increase power. This would add the function of a steam engine powered by the heat of combustion.

6. The system of claim 1, wherein the engine of the type of the present invention may be made with multiple rings of radially aligned pistons and any number of cylinders within those rings therefore providing for an unlimited number of pistons and configurations.

7. The system of claim 1, wherein the ignition devise is either a single spark plug, multiple spark plugs or a combination of spark and glow plugs.

8. The system of claim 1, wherein the engine of the type of the present invention may be made with various locations of the intake passageway, exhaust passageway, and ignition devise within the hub with respect to the cylinder cycles thereby changing their timing with the cycles. This can also be achieved during engine operation by including mechanisms within the hub that change the dimensions and or locations of these devises within the hub. In addition a mechanism that rotates the cam with respect to the hub would have a similar tuning effect by advancing the cylinder cycles.

9. The system of claim 1, wherein the engine of the type of the present invention may be made with various locations of the coolant passageways within the hub to create different cooling effects and provide for liquid or air cooling.

10. The system of claim 1, wherein the engine of the type of the present invention may be made with various locations of coolant passageways within the cylinder block to create different cooling effects.

11. The system of claim 1, wherein the engine of the type of the present invention may be made with various locations of lubricant passageways within the hub to create different lubrication and cooling effects.

12. The system of claim 1, wherein the engine of the type of the present invention may be made with various locations of lubricant passageways within the cylinder block to create different lubricant and cooling effects.

13. The system of claim 1, wherein the engine of the type of the present invention may be made with a sleeve around the piston that also acts as a cylinder liner that is spring loaded to form a tight seal with the hub.

14. The system of claim 1, wherein the engine of the type of the present invention may be made with seals that are spring loaded to form a tight seal between the hub and the cylinder liners.
